(19) United States
(12) Patent Application Publication
(10) Pub. No.: US 2026/0288631 A1
(43) Pub. Date: Sep. 24, 2026

(54) MEMORY SYSTEM

(71) Applicant: Kioxia Corporation, Tokyo (JP)

(72) Inventor: Hiroki YOSHIMOTO, Kawasaki (JP)

(73) Assignee: Kioxia Corporation, Tokyo (JP)

(21) Appl. No.: 19/325,184

(22) Filed: Sep. 10, 2025

(30) Foreign Application Priority Data
Mar. 19, 2025 (JP) 2025-045993

(51) Int. Cl. G06F 12/02; G06F 13/16

(52) U.S. Cl. CPC G06F 12/0246; G06F 13/1621; G06F 13/1673; G06F 2212/7201

(57) ABSTRACT

A memory system is connectable to an information processing device, and includes a non-volatile memory; a volatile memory; and a memory controller operatively coupled to the non-volatile memory and the volatile memory. The memory controller is configured to: manage a plurality of logical-to-physical address conversion tables for associating logical addresses with physical addresses; manage a log including a plurality of logical addresses; and when a first read request for designating a first logical address is received from the information processing device, determine whether a second logical address including the same logical address as the first logical address is included in the log.

### CROSS-REFERENCE TO RELATED APPLICATION

This application is based upon and claims the benefit of priority from Japanese Patent Application No. 2025-045993, filed Mar. 19, 2025, the entire contents of which are incorporated herein by reference.

### FIELD

Embodiments described herein relate generally to a memory system.

### BACKGROUND

As a memory system configured with a host device and a memory device based on a client-server model, a memory system complying with the Universal Flash Storage (UFS) standard is known.

### DESCRIPTION OF THE DRAWINGS

FIG. 1 is a diagram showing the configuration of an information processing system according to an embodiment.

FIG. 2 is a block diagram showing the configuration of a semiconductor memory according to an embodiment.

FIG. 3 is a diagram showing a circuit configuration of a memory cell array of a semiconductor memory according to an embodiment.

FIG. 4 is a diagram showing an example of a logical-to-physical address conversion table managed by a memory system according to an embodiment.

FIG. 5 is a diagram showing an example of a log managed by a memory system according to an embodiment.

FIG. 6 is a flowchart for illustrating a preread operation of a memory system according to an embodiment.

FIG. 7 is a flowchart showing a log recording operation of a memory system according to an embodiment.

### DETAILED DESCRIPTION

Embodiments provide a memory system in which the speed of a read operation is increased.

In general, according to one embodiment, a memory system is connectable to an information processing device, and includes a non-volatile memory; a volatile memory; and a memory controller operatively coupled to the non-volatile memory and the volatile memory. The memory controller is configured to: manage a plurality of logical-to-physical address conversion tables for associating logical addresses with physical addresses; manage a log including a plurality of logical addresses; and when a first read request for designating a first logical address is received from the information processing device, determine whether a second logical address including the same logical address as the first logical address is included in the log.

According to another embodiment, a memory system is a memory system configured to be connected to an information processing device, and includes a nonvolatile memory, a volatile memory, and a memory controller that controls the non-volatile memory and the volatile memory. The memory controller manages a plurality of logical-to-physical address conversion tables for associating logical addresses with physical addresses corresponding to the logical addresses, the plurality of logical-to-physical address conversion tables including a first logical-to-physical address conversion table, and, when a first read request for designating a first logical address is received from the information processing device, the memory controller determines whether the first logical-to-physical address conversion table including the first logical address is included in the volatile memory.

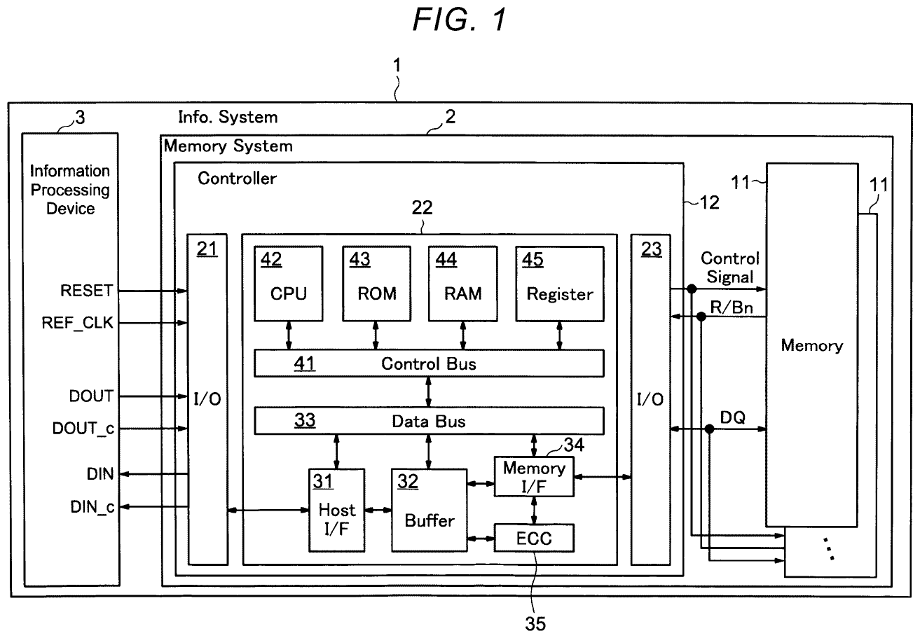

Hereinafter, a memory system according to this embodiment will be specifically described with reference to the drawings. In the following description, elements having substantially the same functions and configurations are given the same reference numerals, and will be described repeatedly only when necessary. The following embodiments illustrates a device and method for embodying the technical idea of this embodiment. The technical idea of the embodiment is not limited to the following materials, shapes, structures, arrangements, and the like of components. The technical idea of the embodiment may be modified in various ways within the scope of the claims.

[1. Overall configuration of information processing system] An information processing system according to this embodiment will be described with reference to FIG. 1. In this embodiment, the information processing system including a host device and a memory device that complies with the UFS standard will be described. FIG. 1 is a diagram showing the configuration of the information processing system according to an embodiment. In FIG. 1, some of connections between blocks are indicated by arrows, but the connections between the blocks are not limited to this configuration.

As shown in FIG. 1, an information processing system (Info. System) 1 includes a memory system 2 and an information processing device 3. The memory system 2 can be connected to the information processing device 3. Specifically, the memory system 2 is configured to be able to communicate with the information processing device 3 on the basis of a client-server model. The memory system 2 operates as a target, and the information processing device 3 operates as an initiator. As a more specific example, the memory system 2 is a UFS memory device, and the information processing device 3 is a host device that supports the UFS memory device. The information processing device 3 is also referred to as a host or a host device. The information processing device 3 may be, for example, a system on chip (SoC) device, and may be a device mounted on a smartphone, a digital camera, or the like.

The memory system 2 includes a non-volatile semiconductor memory (Memory) 11 (hereinafter referred to as a “memory 11”) and a controller 12 for controlling the memory 11. The controller 12 is provided with a volatile memory (for example, a buffer 32 and a RAM 44, which will be described later), as will be described in detail later. The controller 12 is configured to control the memory 11, which is a nonvolatile memory, and the above-mentioned volatile memory.

The memory 11 performs data write and read operations in specific write units configured with a plurality of bits. Furthermore, the memory 11 erases data in erasure units configured with a plurality of write units. For example, the memory 11 includes one or a plurality of NAND type flash memories. When the memory 11 is a NAND type flash memory, the memory 11 performs write and read operations in page units. For example, the memory 11 is a three-dimensional stacked type NAND type flash memory in which memory cell transistors are stacked three-dimensionally above a semiconductor substrate. The memory 11 is not limited to a three-dimensional stacked type NAND type flash memory, and may be a planar type NAND type flash memory in which memory cell transistors are disposed two-dimensionally on a semiconductor substrate, or may be another nonvolatile memory. Details of the memory 11 will be described later.

The controller 12 includes an I/O 21, a core logic unit 22, and an I/O 23. The I/O 21 includes a hardware configuration for connecting the memory system 2 to the information processing device 3. The memory system 2 is connected to the information processing device 3 via a host bus. When the information processing system 1 complies with the UFS standard, the host bus corresponds to a serial interface. Signals transmitted and received between the memory system 2 and the information processing device 3 include RESET, REF_CLK, DOUT, DOUT_c, DIN, and DIN_c. These signals are communicated between the information processing device 3 and the I/O 21 via the host bus. RESET is a hardware reset signal. REF_CLK is a reference clock signal. DOUT and DOUT_c form a differential signal pair and are signals transmitted from the information processing device 3 to the memory system 2. DIN and DIN_c form a differential signal pair and are signals transmitted from the memory system 2 to the information processing device 3.

The core logic unit 22 is a main part of the controller 12 excluding the I/O 21 and the I/O 23. The I/O 23 includes a hardware configuration for connecting the controller 12 to the memory 11.

The core logic unit 22 includes a host interface (Host I/F) 31, a buffer 32, a data bus 33, a memory interface (Memory I/F) 34, an error-correcting code (ECC) circuit 35, a control bus 41, a central processing unit (CPU) 42, a read only memory (ROM) 43, a random access memory (RAM) 44, and a register 45.

The I/O 21 is connected to the host interface 31. The host interface 31 performs processing required for communication between the memory system 2 and the information processing device 3. More specifically, the host interface 31 is responsible for communication between the memory system 2 and the information processing device 3 in accordance with a communication protocol with which both the memory system 2 and the information processing device 3 comply. For example, when the memory system 2 is a UFS memory device, the host interface 31 is a UFS interface. The UFS interface complies with the M-PHY standard for a physical layer and the UniPro standard for a link layer.

The host interface 31 is connected to the buffer 32, which is a volatile memory. The buffer 32 receives data transmitted from the information processing device 3 to the memory system 2 via the host interface 31 and temporarily stores the data. The buffer 32 temporarily stores data transmitted from the memory system 2 to the information processing device 3 via the host interface 31. The buffer 32 is connected to the data bus 33.

The I/O 23 is connected to the memory interface 34. The memory interface 34 performs processing required for the controller 12 to communicate with the memory 11. More specifically, the memory interface 34 transmits an instruction (control signal) from the core logic unit 22 to the memory 11 in a form that can be recognized by the memory 11. Furthermore, the memory interface 34 transmits and receives a signal DQ to and from the memory 11, and receives a ready/busy signal R/Bn from the memory 11. The signal DQ includes, for example, data, an address, and a command. The signal R/Bn is a signal indicating that the memory 11 is in a busy state or a ready state. When the memory 11 is a NAND type flash memory, the memory interface 34 is a NAND flash interface.

The memory interface 34 is connected to the buffer 32, which is a volatile memory. The buffer 32 receives data transmitted from the memory 11 to the controller 12 via the memory interface 34 and temporarily stores the data. The buffer 32 also temporarily stores data transmitted from the controller 12 to the memory 11 via the memory interface 34. The buffer 32 is connected to the data bus 33.

The memory interface 34 and the buffer 32 are connected to the ECC circuit 35. The ECC circuit 35 receives write data from the information processing device 3 via the data bus 33, adds an error correction code (hereinafter referred to as “parity”) to the write data, and supplies the write data with the parity to the buffer 32. The ECC circuit 35 receives data sent from the memory 11 via the buffer 32, performs error correction using the parity added to the data, and supplies the error-corrected data to the data bus 33.

The control bus 41 is connected to a CPU 42, a ROM 43, a RAM 44, and a register 45. These circuits communicate with each other via the control bus 41.

The CPU 42 controls the overall operation of the memory system 2. The CPU 42 executes a predetermined process (such as a write operation, a read operation, or an erase operation) in accordance with a control program (instruction) stored in the ROM 43. The CPU 42 executes a predetermined process for the memory 11 in accordance with, for example, a command received from the information processing device 3.

The CPU 42 manages data (hereinafter referred to as “logical-to-physical address l conversion data” or “logical-to-physical address conversion table”) for associating a logical address designated by the information processing device 3 with a physical address corresponding to the logical address. The physical address is an address for specifying a physical position in a memory space of the memory 11. The logical address is an address recognized by the information processing device 3. The CPU 42 manages a plurality of logical-to-physical address conversion tables. The logical-to-physical address conversion table is stored in the memory 11, and is read out from the memory 11 as necessary and temporarily stored in the RAM 44.

As will be described later in detail, when the CPU 42 receives a read request (first read request) for designating a certain specific logical address (first logical address) from the information processing device 3, the CPU 42 has a function of determining whether a logical-to-physical address conversion table (first logical-to-physical address conversion table) including the first logical address is provided in the RAM 44. When the first logical-to-physical address conversion table is not stored in the RAM 44, the CPU 42 reads out the first logical-to-physical address conversion table from the memory 11 and stores it in the RAM 44.

In addition to the logical-to-physical address conversion table, the CPU 42 manages a log including a plurality of logical addresses. As will be described later in detail, the log includes a plurality of logical addresses. When the CPU 42 receives the first read request, the CPU 42 has a function of determining whether there is the first logical-to-physical address conversion table, or instead of having the determination function, the CPU 42 has a function of determining whether the log includes the same logical address as the first logical address. When the CPU 42 determines that the log includes the same logical address as the first logical address, the CPU 42 reads data corresponding to the logical address from the memory 11 and stores the data in the buffer 32 on the basis of the log.

When the CPU 42 receives a read request including a command and a logical address from the information processing device 3, the CPU 42 reads a logical-to-physical address conversion table, which corresponds to the logical address to be read from a plurality of logical-to-physical address conversion tables stored in the memory 11, into the RAM 44, and converts the logical address into a physical address. When the CPU 42 receives a write request including a command, write data, and a logical address from the information processing device 3, the CPU 42 newly assigns a physical address corresponding to the logical address.

The ROM 43 stores a control program and the like executed by the CPU 42. The RAM 44 is a volatile memory, and temporarily stores the logical-to-physical address conversion table stored in the memory 11 and a log to be described later. The RAM 44 is used as a working area for the CPU 42, and temporarily stores variables and the like required for the work of the CPU 42. The register 45 stores various values required for the operation of the memory system 2. The register 45 may also be configured to store various values required for the information processing device 3 to control the memory system 2.

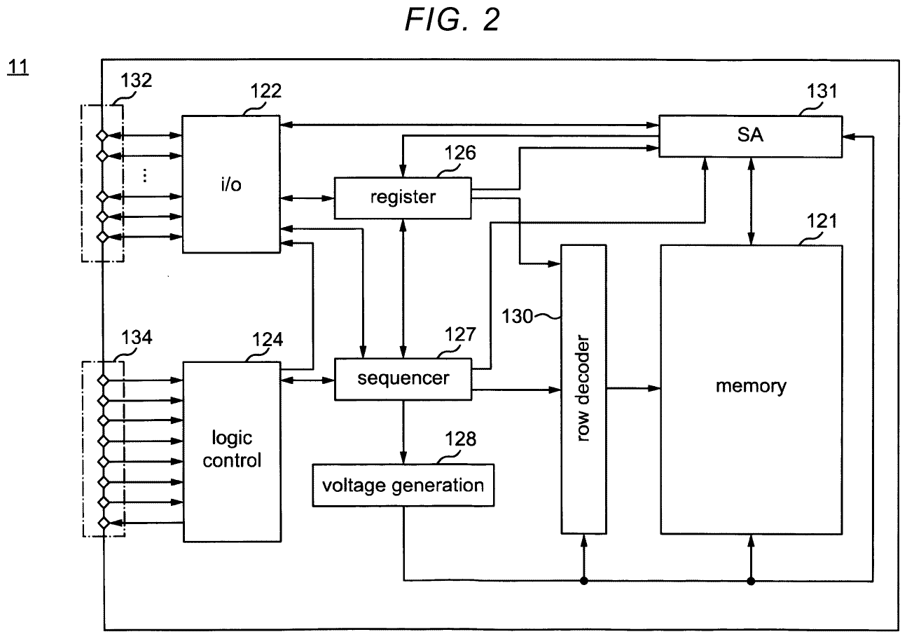

The host interface 31, the buffer 32, and the memory interface 34 are further connected to the control bus 41. The CPU 42 controls the host interface 31, the buffer 32, and the memory interface 34 on the basis of the control program or instructions from the information processing device 3.

[2. Configuration of semiconductor memory] An example of the configuration of the semiconductor memory according to this embodiment will be described with reference to FIG. 2. FIG. 2 is a block diagram showing the configuration of a semiconductor memory according to an embodiment. In the following description, a case where the plurality of memories 11 have the same configuration will be described, but the plurality of memories 11 may have different configurations.

As shown in FIG. 2, the memory 11 includes a memory cell array 121 (memory), an input/output circuit 122 (i/o), a logic control circuit 124 (logic control), a register 126, a sequencer 127, a voltage generation circuit 128 (voltage generation), a row decoder 130, a sense amplifier 131 (SA), an input/output pad group 132, and a logic control pad group 134.

The memory cell array 121 includes a plurality of non-volatile memory cells (memory cell transistors MT to be described later) associated with word lines and bit lines, as will be described later in detail.

The input/output circuit 122 transmits and receives data signals to and from the controller 12. The input/output circuit 122 transfers commands and addresses in the data signals to the register 126. The input/output circuit 122 transmits and receives write data and read data to and from the sense amplifier 131.

The logic control circuit 124 receives, for example, a chip enable signal, a command latch enable signal, an address latch enable signal, a write enable signal, a read enable signal, an output instruction signal, and a write protect signal from the controller 12. The logic control circuit 124 transmits a ready/busy signal to the controller 12 to notify the controller 12 of the state of the semiconductor memory 11.

The register 126 stores a command and an address. The register 126 transfers the address to the row decoder 130 and the sense amplifier 131, and transfers the command to the sequencer 127. The sequencer 127 receives the command and controls the entire semiconductor memory 11 in accordance with a sequence based on the received command.

The voltage generation circuit 128 generates voltages required for data write, read, and erase operations on the basis of instructions received from the sequencer 127. The voltage generation circuit 128 includes a plurality of drivers, and applies the generated voltages to the row decoder 130 and the sense amplifier 131 under the control of the sequencer 127. The voltage generation circuit 128 applies the generated voltage to the corresponding row decoder 130 on the basis of, for example, a row address provided in an instructed address.

The row decoder 130 selects a memory cell corresponding to the row address provided in the instructed address under the control of the sequencer 127. A voltage applied from the voltage generation circuit 128 via the row decoder 130 is applied to memory cells of the selected row.

The sense amplifier 131 detects read data read from the memory cell to a bit line during a data read operation, and transfers the detected read data to the input/output circuit 122. During a data write operation, the sense amplifier 131 transfers data to be written via the bit line to the memory cell. The sense amplifier 131 transfers data corresponding to an instructed address to the input/output circuit 122 under the control of the sequencer 127.

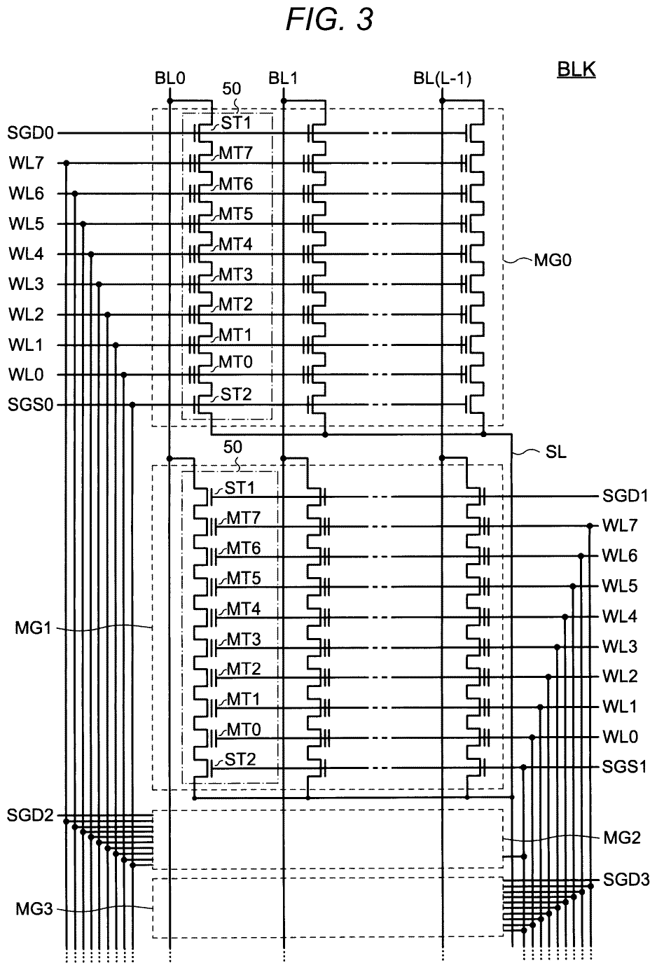

The input/output pad group 132 transfers data signals received from the controller 12 to the input/output circuit 122. The input/output pad group 132 transfers data signals received from the input/output circuit 122 to the controller 12. The logic control pad group 134 transfers various signals received from the controller 12 to the logic control circuit 124.

[3. Configuration of memory cell array] A circuit configuration of the memory cell array 121 will be described with reference to FIG. 3. FIG. 3 is an equivalent circuit diagram of a block BLK. As shown in the drawing, the block BLK includes a plurality of memory groups MG (MG0, MG1, MG2, ...). The memory group MG includes a plurality of strings 50.

In this embodiment, the string 50 includes eight memory cell transistors MT (MT0 to MT7) and two select transistors ST (ST1, ST2). The eight memory cell transistors MT are connected in series between a source of the select transistor ST1 and a drain of the select transistor ST2.

In this embodiment, the number of memory cell transistors MT provided in the string 50 is eight, but this is not limited to this configuration. For example, the number of memory cell transistors MT provided in the string 50 may be seven or less, or nine or more. The number of select transistors ST is also not limited to the above configuration.

As will be described later in detail, the memory cell transistor MT includes a gate electrode that controls an on state and an off state of the transistor, and a charge storage layer that holds charges injected by a write operation. The memory cell transistor MT has a threshold voltage according to the amount of charges held by the charge storage layer, and is turned on when a voltage equal to or greater than the threshold voltage is applied to the gate electrode.

When a write operation is performed on the memory cell transistor MT, that is, when electrons are injected into the charge storage layer of the memory cell transistor MT, the threshold voltage of the memory cell transistor MT changes. When the memory cell is an N-type transistor, the threshold voltage of the memory cell transistor MT in a state where electrons are injected into the charge storage layer is higher than the threshold voltage of the memory cell transistor MT in a state where electrons are not injected into the charge storage layer. The memory cell transistor MT stores data in a non-volatile manner by a change in the threshold voltage due to electrons being injected into the charge storage layer.

As shown in FIG. 3, a gate of the select transistor ST1 in the memory group MG is connected to a select gate line SGD (SGD0, SGD1, ...). A gate of the select transistor ST2 is connected to a select gate line SGS (SGS0, SGS1, ...). The select gate lines SGD and SGS are independently controlled by the row decoder 130. In this embodiment, a configuration in which the number of select gate lines SGD and the number of select gate lines SGS are one is illustrated, but this configuration is not limited thereto. The number of select gate lines SGD and the number of select gate lines SGS may be two or more. In other words, two or more select transistors ST1 and ST2 may be provided.

The gate electrodes of the memory cell transistors MT0 to MT7 that are provided in the same memory group MG and belong to different bit lines BL are connected to word lines WL0 to WL7, respectively. The word lines WL (WL0 to WL7) are independently controlled by the row decoder 130.

A block BLK is, for example, a data erasure unit. That is, data stored by the memory cell transistors MT provided in the same block BLK is erased all at once. When the memory cell is an N-type transistor, the threshold voltage of the memory cell transistor MT in a state where data is erased (erased state) is lower than the threshold voltage of the memory cell transistor MT in a state where data is written (written state).

In the memory cell array 121, the drains of the select transistors ST1 of the plurality of strings 50 provided in the same column are connected to a common bit line BL (BL0 to BL(L-1) (L is a natural number equal to or greater than 3). In the memory cell array 121, the sources of the plurality of select transistors ST2 are connected in common to a source line SL.

The memory cell transistor MT includes a channel portion, a charge storage layer, and a gate electrode. The channel portion is a portion that functions as a channel of the memory cell transistor MT. The charge storage layer holds charges injected by a write operation. A threshold voltage of the memory cell transistor MT varies depending on the amount of charges held in the charge storage layer. The gate electrode is connected to the word line WL. The channel portion, the charge storage layer, and the gate electrode are insulated from each other by an insulating layer.

The charge storage layer may be, for example, a floating gate such as a metal layer, or may be a charge trap layer such as a silicon nitride layer. The memory cell transistor MT may be a memory cell including a ferroelectric insulating layer. In this case, the ferroelectric insulating film is provided between the channel portion and the gate electrode, and the threshold voltage of the memory cell transistor MT changes as a dielectric constant changes.

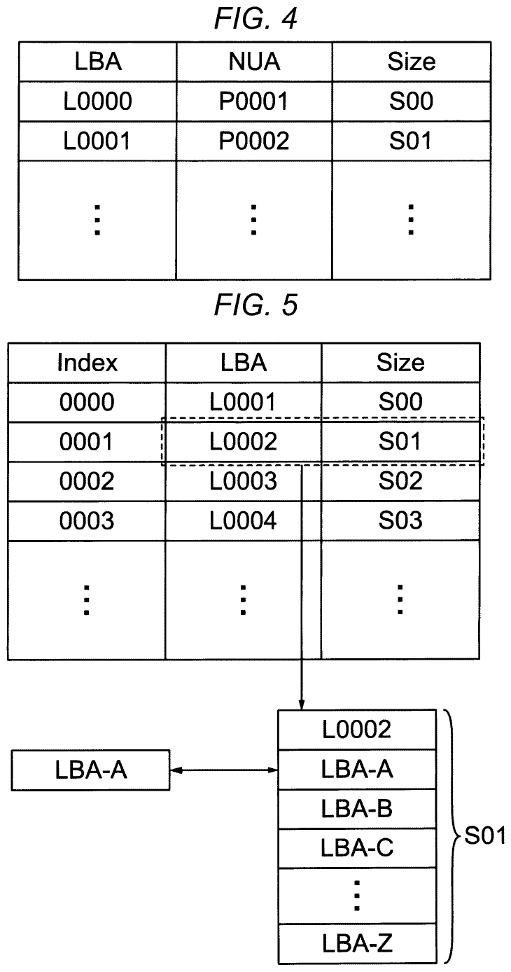

The select transistor ST includes a channel portion and a gate electrode. The select transistor ST is not provided with a charge storage layer. The gate electrode of the select transistor ST1 is connected to the select gate line SGD. The gate electrode of the select transistor ST2 is connected to the select gate line SGS. Unlike the example in FIG. 3, the select transistor ST may be provided with a charge storage layer.

[4. Logical-to-physical conversion table] The configuration of a logical-to-physical address conversion table will be described with reference to FIG. 4. FIG. 4 is a diagram showing an example of a logical-to-physical address conversion table managed in the memory system according to the embodiment. As described above, the logical-to-physical address conversion table is a table for converting a logical address to be read into a physical address, for example, in a read operation. As shown in FIG. 4, in the logical-to-physical address conversion table, a logical address (LBA), a physical address (PBA), and size information (Size) are associated with each other. In the logical-to-physical address conversion table, pieces of data arranged in a row direction are associated with each other, and a group of associated data may be referred to as a record.

The logical address indicates a top address to be read. The size information means the amount of data from the top address. That is, the range of the logical address to be read is determined on the basis of the logical address and the size information. The physical address indicates a specific memory cell associated with the logical address among the plurality of memory cells provided in the memory 11. That is, the range of the physical address to be read is determined on the basis of the physical address and the size information.

The logical-to-physical address conversion table is stored in the memory 11. In a read operation according to a read request from the information processing device 3, the logical-to-physical address conversion table corresponding to the logical address to be read is read by the controller 12 and temporarily stored in the RAM 44. Here, in a memory system according to a comparative example, it is possible to store a small amount of logical-to-physical address conversion table in the RAM, but there is a limit to the capacity of the RAM, and thus the entire logical-to-physical address conversion table cannot be stored in the RAM. When the logical-to-physical address conversion table corresponding to the read request is not stored in the RAM, the logical-to-physical address conversion table is read from the memory 11 to the RAM every time a read request is made. Reading this logical-to-physical address conversion table is a factor that reduces the speed of a response to a read request. For example, in a UFS device equipped with a function specialized for high-speed reading, such as “file based optimization (FBO)” or “WB2.0 Pinned”, a fast response speed to such a read request is preferable.

In the memory system according to this embodiment, in response to a read request, it is determined whether a logical-to-physical address conversion table corresponding to a logical address to be read is stored in the RAM 44. When the logical-to-physical address conversion table is stored in the RAM 44, data is read using the already stored logical-to-physical address conversion table. When the logical-to-physical address conversion table corresponding to the logical address to be read is not stored in the RAM 44, a preread operation is performed by referring to a log, as will be described in detail below, and thus it is possible to suppress a decrease in response speed caused by reading of the logical-to-physical address conversion table as described above.

[5. Log] The configuration of a log will be described with reference to FIG. 5. FIG. 5 is a diagram showing an example of a log managed in the memory system according to the embodiment. As shown in FIG. 5, in the log, an index (Index), a logical address (LBA), and size information (Size) are associated with each other.

The index is a value indicating the order in which information is recorded in the log. In other words, the index is a value assigned in time series. In other words, the log shown in FIG. 5 means that a read operation was performed in the order of indexes “0000”, “0001”, “0002”, and “0003”. For example, the value of the index is a value that increases in time series as shown in FIG. 5.

On the other hand, the logical address and the size information are any values. The logical address and the size information are the same as those in FIG. 4, and thus the description thereof will be omitted. FIG. 5 shows a case where logical addresses indicated by data corresponding to the index (0001), that is, data having a size of S01 starting from a logical address (L0002), are “L0002”, “LBA-A”, “LBA-B”, “LBA-C”, ..., and “LBA-Z”. Furthermore, FIG. 5 shows a case where a first logical address designated by a first read request is “LBA-A”.

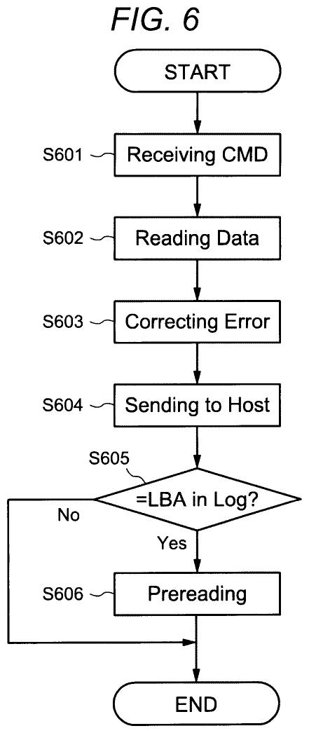

The log is stored in the RAM 44 in a state where the memory system 2 is started up. When the memory system 2 transitions to a pause state or a sleep state, the controller 12 moves the log from the RAM 44 to the memory 11.

[6. Preread operation] A read operation of the memory system 2 will be described with reference to FIGS. 5 and 6. FIG. 6 is a flowchart showing a preread operation of the memory system according to the embodiment. The operation shown in FIG. 6 is implemented by the CPU 42 of the controller 12 executing a program stored in the RAM 44. FIG. 6 shows an operation of reading data using a logical address recorded in a log when a logical address that is a target of the read operation is provided in the logical address recorded in the log.

As shown in FIG. 6, the controller 12 receives a first read request from the information processing device 3 (step S601; Receiving CMD). In the first read request, a first logical address to be read and a data length from the first logical address are designated. When the controller 12 receives the first read request, the controller 12 reads data stored in a physical address corresponding to the first logical address from the memory 11 on the basis of a first logical-to-physical address conversion table including the first logical address (step S602; Reading Data). The controller 12 performs error correction on the data read from the memory 11 by using the ECC circuit 35 (step S603; Correcting Error), and transmits the error-corrected data to the information processing device 3 as a read result in response to the read request (step S604; Sending to Host).

After transmitting a read result to the information processing device 3, the controller 12 determines whether the same logical address as the first logical address is provided in the log (step S605; =LBA in Log?). Hereinafter, a logical address designated by a logical address (LBA) and size information (Size) of the log will be referred to as a “second logical address”. As shown in FIG. 5, the log includes four second logical addresses corresponding to indexes “0000” to “0003”. In S605, it is determined whether there is a second logical address that includes the same logical address as the first logical address among the plurality of second logical addresses provided in the log. Specifically, in the case of the log shown in FIG. 5, it is determined whether there is a logical address that is the same as the first logical address “LBA-A” among the four second logical addresses.

In S605, when it is determined that the log includes a second logical address that includes the same logical address as the first logical address (“Yes” in S605), the controller 12 reads, from the memory 11, a logical-to-physical address conversion table and/or data corresponding to a logical address that is provided in the second logical address and is different from the first logical address on the basis of the log, and stores it in the buffer 32 (step S606; Preread). That is, the controller 12 reads, from the memory 11, a logical-to-physical address conversion table and/or data corresponding to not only the first logical address “LBA-A” but also the logical addresses “LBA-B” to “LBA-Z” provided in the second logical address, and stores it in the buffer 32. Some or all of the logical addresses “LBA-B” to “LBA-Z” may be referred to as a “fourth logical address”. In this case, it can be said that the second logical address includes a fourth logical address (“LBA-B” to “LBA-Z”) that is different from the first logical address (LBA-A).

In other words, in the above-described configuration, as shown in S601 to S604, the controller 12 transmits the data read from the memory 11 in response to the first read request to the information processing device 3, and then stores the data corresponding to the second logical address in the buffer 32.

In this embodiment, a configuration in which S605 is performed after S604 is described, but this is not limiting. For example, S605 may be performed at any timing after S601.

Detailed operations of S606 will be described with reference to FIG. 5. In FIG. 5, a read request transmitted from the information processing device 3 before the first read request is referred to as a second read request. An address designated by the second read request is a second logical address, which is a logical address (“L0002” to “LBA-Z”) corresponding to the index “0001”. A read request transmitted from the information processing device 3 before the first read request and after the second read request is referred to as a third read request. An address designated by the third read request is a third logical address, which is a logical address corresponding to the index “0002” (a logical address having a size of S02 and starting from a logical address (L0003)).

The index “0001” is referred to as a “first index”, and the index “0002” is referred to as a “second index”. In a time-series order, the second index (0002) is after the first index (0001). The second logical address (“L0002” to “LBA-Z”) is associated with the first index (0001). The third logical address (starting point: L0003, size S02) is associated with the second index (0002). In this embodiment, the value of an index increases in time series, and thus a value assigned to the first index is smaller than a value assigned to the second index.

When the operation of S605 in FIG. 6 is described using the above expression, f1irst, the controller 12 determines whether the same logical address as the first logical address (LBA-A) designated by the first read request is provided in the log. When description is given with reference to FIG. 5, in S605, it is determined whether the same logical address as the first logical address (LBA-A) is provided in the logical addresses designated by the logical address and the size information of the log.

In this embodiment, the log shown in FIG. 5 includes a second logical address (a logical address corresponding to index (0001)) including the same logical address as the first logical address (LBA-A), and thus the controller 12 reads, from the memory 11, a logical-to-physical address conversion table and/or data corresponding to “LBA-B” to “LBA-Z” from the size information of S01 starting from the second logical address (L0002) associated with the first index (0001), and stores it in the buffer 32. In other words, the controller 12 reads, from the memory 11, a logical-to-physical address conversion table and data corresponding to not only the first logical address (LBA-A) designated by the first read request, but also the logical addresses “LBA-B” to “LBA-Z” that are presumed to be read next, and stores it in the buffer 32 before the controller 12 receives a read request for these logical addresses.

In this case, the controller 12 reads the logical-to-physical address conversion table corresponding to the logical addresses “LBA-B” to “LBA-Z” from the memory 11 on the basis of the first read request, and stores it in the buffer 32. Then, the controller 12 specifies a physical address corresponding to the logical addresses “LBA-B” to “LBA-Z” by using the logical-to-physical address conversion table corresponding to “LBA-B” to “LBA-Z” stored in the buffer 32, reads the data corresponding to the logical addresses “LBA-B” to “LBA-Z” from the memory 11 by using the specified physical address, and stores the read data in the buffer 32.

Alternatively, the controller 12 reads the data corresponding to the logical addresses “LBA-B” to “LBA-Z” from the memory 11 on the basis of the first read request, and stores it in the buffer 32. This operation is referred to as data prereading.

Alternatively, the controller 12 reads the logical-to-physical address conversion table corresponding to the logical addresses “LBA-B” to “LBA-Z” from the memory 11 on the basis of the first read request, and stores it in the buffer 32. This operation is referred to as prereading of the logical-to-physical address conversion table.

Following the prereading of the data, the controller 12 may read, from the memory 11, data having a size of S02 starting from the third logical address (L0003) associated with the second index (0002), which is presumed to be read after the second logical address (L0002), and store it in the buffer 32.

Furthermore, following the prereading of the logical-to-physical address conversion table, the controller 12 may read, from the memory 11, a logical-to-physical address conversion table having a size of S02, starting from the third logical address (L0003) associated with the second index (0002), which is presumed to be read after the second logical address (L0002), and store it in the buffer 32.

Considering the information recorded in the log, in the past read operation, the data of the first logical address (LBA-A) corresponding to the index “0001” is read, and then data of the logical addresses “LBA-B” to “LBA-Z” are read. For example, when specific application software is started up, a regular data read operation may be performed.

Referring to the example in FIG. 5, when it is necessary to continuously read the data of the logical addresses “LBA-A” to “LBA-Z” corresponding to the index “0001” in order to start up the application software, and when a logical address designated in the read request received from the information processing device 3 is “LBA-A”, it is estimated that there is a high possibility that the data of the logical addresses “LBA-B” to “LBA-Z” will be read.

Thus, before the controller 12 receives a read request for designating the logical addresses “LBA-B” to “LBA-Z” from the information processing device 3, the controller 12 reads the data of the logical addresses “LBA-B” to “LBA-Z” from the memory 11 and stores it in the buffer 32. That is, instead of reading data including the logical addresses “LBA-B” to “LBA-Z” from the memory 11 after receiving these read requests, the controller 12 reads the data of the logical addresses “LBA-B” to “LBA-Z” from the memory 11 prior to receiving these read requests, and stores the data in the buffer 32. By prereading the data and storing it in the volatile memory in this manner, data corresponding to a read request can be obtained without reading data from the non-volatile memory every time a read request is made.

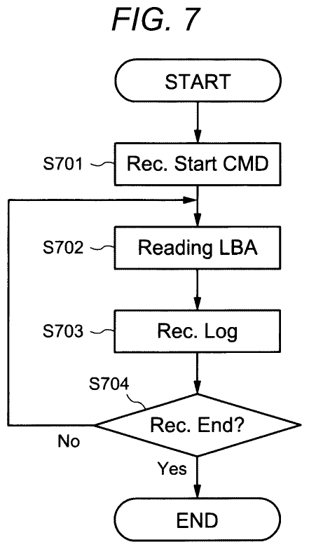

In addition, before the controller 12 receives a read request for designating the logical addresses “LBA-B” to “LBA-Z” from the information processing device 3, the controller 12 reads the logical-to-physical address conversion table corresponding to the logical addresses “LBA-B” to “LBA-Z” from the memory 11 and stores it in the buffer 32. That is, instead of reading the logical-to-physical address conversion table corresponding to the logical addresses “LBA-B” to “LBA-Z” from the memory 11 after receiving these read requests, the controller 12 reads the logical-to-physical address conversion table corresponding to the logical addresses “LBA-B” to “LBA-Z” from the memory 11 prior to receiving these read requests and stores it in the buffer 32. By prereading the logical-to-physical address conversion table and storing it in the volatile memory in this manner, a physical address corresponding to a logical address designated in the subsequent read request can be specified using the logical-to-physical address conversion table stored in the volatile memory, and a period of time required to specify the physical address can be shortened compared to a case where the physical address corresponding to the logical address designated in the subsequent read request is specified using the logical-to-physical address conversion table stored in the non-volatile memory.

[7. Log recording operation] A log recording operation of the memory system 2 will be described with reference to FIG. 7. FIG. 7 is a flowchart showing a log recording operation of the memory system according to the embodiment. The operation shown in FIG. 7 is implemented by the CPU 42 of the controller 12 executing a program stored in the RAM 44. FIG. 7 shows an operation in which a log recording range is determined in response to a request from the information processing device 3.

As shown in FIG. 7, the controller 12 receives a request to start log recording from the information processing device 3 (step S701; Rec. Start CMD). In the request to start log recording, a specific logical address is designated. For example, when a user who operates the information processing device 3 desires to increase the speed of a read operation for an operation from starting up specific application software to performing a predetermined setting, a logical address of data to be read first to start the application software is designated in S701.

Subsequently to S701, when the controller 12 receives a read request for the designated logical address from the information processing device 3 (step S702; Reading LBA), the controller 12 reads data corresponding to the logical address corresponding to the read request from the memory 11, and records the logical address and size information indicating the length of the read data in a log (step S703; Rec. Log). Subsequently to S703, the controller 12 determines whether a request to end the log recording is received (step S704; Rec. End?). When it is determined in S704 that the controller 12 does not receive a request to end the log recording (“No” in S704), the processing returns to S702. On the other hand, when it is determined in S704 that the controller 12 receives a request to end the log recording (“Yes” in S704), the operation shown in FIG. 7 ends.

Details of the operation of S703 will be described with reference to FIG. 5. In the following description, the size information S01 corresponding to the index “0001” is referred to as “first size information”. The size information S02 corresponding to the index “0002” is referred to as “second size information”. In the step of creating the log shown in FIG. 5, when the controller 12 records the information corresponding to the index “0001” in the log, the controller 12 records the second logical address (L0002) and the first size information (S01) in the log. The first size information is information indicating the length of data from the second logical address. The controller 12 records the information corresponding to the index “0002” in the log after recording the information corresponding to the index “0001”. At this time, the controller 12 records the third logical address (L0003) and the second size information (S02) in the log.

The request to start the log recording in S701 is referred to as a “first request”. The request to end the log recording in S704 is referred to as a “second request”. In this case, the controller 12 determines the second logical address (L0002) and the third logical address (L0003) on the basis of the first request received from the information processing device 3. Similarly, the controller 12 determines the first size information (S01) and the second size information (S02) on the basis of the second request received from the information processing device 3. A log is created by such an operation.

In this embodiment, a configuration in which a user operating the information processing device 3 designates the start and end of the log recording is exemplified, but the configuration is not limited thereto. For example, a log may be recorded for a file for which the user does not have the authority to operate it.

In this embodiment, a configuration in which data corresponding to a logical address designated by a read request is read when creating a log is exemplified, but the configuration is not limited thereto. For example, when a read request is received from the information processing device 3, a logical address and size information specified by the read request may be recorded in a log without reading data corresponding to the read request.

As described above, according to the information processing system 1 in this embodiment, it is possible to increase the speed of a read operation by prereading a logical-to-physical address conversion table or data corresponding to a logical address designated by a read request.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

Even when there are operational effects different from those obtained by the aspects of the configurations described above, those that are apparent from the description of the present specification or those that can be easily predicted by a person skilled in the art are naturally regarded as operational effects obtained by the present disclosure.

What is claimed is:

1. A memory system connectable to an information processing device, the memory system comprising:
a non-volatile memory;
a volatile memory; and
a memory controller configured to control the non-volatile memory and the volatile memory,
wherein the memory controller is configured to:
manage a plurality of logical-to-physical address conversion tables for associating logical addresses with physical addresses;
manage a log including a plurality of logical addresses; and
when a first read request for designating a first logical address is received from the information processing device, determine whether a second logical address including the same logical address as the first logical address is provided in the log.

2. The memory system according to claim 1, wherein, in response to determining that the second logical address is included in the log, the memory controller is configured to store data corresponding to the second logical address in the volatile memory, based on the log.

3. The memory system according to claim 1, wherein
the second logical address is designated by a second read request transmitted from the information processing device,
the second read request is transmitted from the information processing device before the first read request,
the log further includes a first index and a second index recorded in the log before the first index,
the first logical address is associated with the first index,
the second logical address is associated with the second index, and
the memory controller is configured to store data corresponding to the second index in the volatile memory, in response to determining that the second logical address is included in the log.

4. The memory system according to claim 3, wherein
the memory controller is configured to receive a third read request for designating a third logical address from the information processing device,
the third read request is transmitted from the information processing device before the first read request and after the second read request,
the log further includes a third index recorded in the log before the first index and after the second index,
the third logical address is associated with the third index, and
in response to determining that the second logical address is present in the log, the memory controller is configured to store data corresponding to the second index and data corresponding to the third index in the volatile memory.

5. The memory system according to claim 4, wherein a value assigned to the second index is smaller than a value assigned to the first index.

6. The memory system according to claim 2, wherein
the second logical address includes a fourth logical address different from the first logical address, and
the memory controller is configured to store data corresponding to the fourth logical address in the volatile memory.

7. The memory system according to claim 1, wherein
the second logical address is designated by a second read request transmitted from the information processing device,
the second read request is transmitted from the information processing device before the first read request, and
the memory controller is configured to record, in the log, the first logical address and first size information indicating a data length from the first logical address to be read, based on the first read request, and record, in the log, the second logical address and second size information indicating a data length from the second logical address to be read, based on the second read request.

8. The memory system according to claim 7, wherein the memory controller is configured to:
determine the first logical address and the second logical address, based on a first instruction received from the information processing device, and
determine the first size information and the second size information, based on a second instruction received from the information processing device after the first instruction.

9. The memory system according to claim 1, wherein the memory controller is configured to transmit data read from the non-volatile memory in response to the first read request to the information processing device, and then store data corresponding to the second logical address in the volatile memory.

10. A memory system connectable to an information processing device, the memory system comprising:
a non-volatile memory;
a volatile memory; and
a memory controller operatively coupled to the non-volatile memory and the volatile memory,
wherein the memory controller is configured to: manage a plurality of logical-to-physical address conversion tables for associating logical addresses with physical addresses, the plurality of logical-to-physical address conversion tables including a first logical-to-physical address conversion table; and
when a first read request for designating a first logical address is received from the information processing device, determine whether the first logical-to-physical address conversion table including the first logical address is included in the volatile memory.

11. The memory system according to claim 10, wherein the memory controller is configured to:
manage a log including a plurality of logical addresses in the volatile memory; and
determine whether a second logical address including the same logical address as the first logical address is included in the log.

12. The memory system according to claim 11, wherein, in response to determining that the second logical address is included in the log, the memory controller is configured to store data corresponding to the second logical address in the volatile memory, based on the log.

13. The memory system according to claim 11, wherein
the second logical address is designated by a second read request transmitted from the information processing device,
the second read request is transmitted from the information processing device before the first read request,
the log further includes a first index,
the second logical address is associated with the first index, and
in response to determining that the second logical address is included in the log, the memory controller is configured to store data corresponding to the first index in the volatile memory.

14. The memory system according to claim 13, wherein
the memory controller is configured to receive a third read request for designating a third logical address from the information processing device,
the third read request is transmitted from the information processing device before the first read request and after the second read request,
the log further includes a second index that is after the first index in a time-series order,
the third logical address is associated with the second index, and
in response to determining that the second logical address is present in the log, the memory controller is configured to store data corresponding to the first index and data corresponding to the second index in the volatile memory.

15. The memory system according to claim 14, wherein a value assigned to the first index is smaller than a value assigned to the second index.

16. The memory system according to claim 11, wherein
the second logical address includes a fourth logical address different from the first logical address, and
in response to determining that the second logical address is included in the log, the memory controller is configured to store, in the volatile memory, a logical-to-physical address conversion table corresponding to the fourth logical address among the plurality of logical-to-physical address conversion tables, based on the log.

17. The memory system according to claim 11, wherein
the second logical address is designated by a second read request transmitted from the information processing device,
the second read request is transmitted from the information processing device before the first read request,
the memory controller is configured to receive a third read request for designating a third logical address from the information processing device,
the third read request is a transmitted from the information processing device before the first read request and after the second read request, and
the memory controller is configured to record, in the log, the second logical address and first size information indicating a data length from the second logical address to be read, based on the second read request, and records, in the log, the third logical address and second size information indicating a data length from the third logical address to be read, based on the third read request.

18. The memory system according to claim 17, wherein the memory controller is configured to:
determine the second logical address and the third logical address, based on a first request received from the information processing device, and
determine the first size information and the second size information, based on a second request received from the information processing device after the first request.

19. The memory system according to claim 12, wherein the memory controller is configured to transmit data, which is read from the non-volatile memory in response to the first read request, to the information processing device, and then store data corresponding to the second logical address in the volatile memory.

20. The memory system according to claim 16, wherein
the plurality of logical-to-physical address conversion tables are stored in the non-volatile memory, and
the memory controller is configured to store the logical-to-physical address conversion table corresponding to the fourth logical address among the plurality of logical-to-physical address conversion tables, which are stored in the non-volatile memory, in the volatile memory.
